(19) United States
(12) Patent Application Publication
(10) Pub. No.: US 2015/0022001 A1
(43) Pub. Date: Jan. 22, 2015

(54) MODULAR GRID POWER BACKUP SYSTEM

(71) Applicant: ASPECT SOLAR PTE LTD., Singapore (SG)

(72) Inventors: ESMOND T. GOEI, BROOMFIELD, CO (US); ANDREW GOEI, BROOMFIELD, CO (US); U KYAW THU RA, SINGAPORE (SG); YEN CHIN, SINGAPORE (SG); HARYADI MAMYO, SINGAPORE (SG); MOK TIONG TAN, SINGAPORE (SG); HSIN WOH MAH, SINGAPORE (SG); RYAN MEJIA, SINGAPORE (SG)

(21) Appl. No.: 14/335,271

(22) Filed: Jul. 18, 2014

Related U.S. Application Data
(60) Provisional application No. 61/856,698, filed on Jul. 20, 2013.

(51) Int. Cl. H02J 7/00; H02J 7/35; H02J 9/06

(52) U.S. Cl. CPC H02J 7/0068; H02J 9/06; H02J 7/0013; H02J 7/35; H02J 2007/0098
USPC 307/65; 320/113; 320/101

(57) ABSTRACT

A modular power backup system has a plurality of smart battery packs for storing electrical energy. Each of the plurality of smart battery packs includes a first power and control connector. A battery pack rack defines a plurality of slots for holding the plurality of smart battery packs. Each of the plurality of slots includes a second power and control connector for interconnecting with the first power and control connector of a smart battery pack of the plurality of smart battery packs. First control circuitry associated with the at least one battery pack rack selectively pools electrical energy from the plurality of smart battery packs into one or more electrical energy outputs.

### CROSS-REFERENCE TO RELATED APPLICATIONS

This application claims benefit of U.S. Provisional Application No. 61/856,698, filed Jul. 20, 2013, entitled MODULAR CUSTOMER PREMISES GRID POWER BACKUP SYSTEM (Atty. Dkt. No. ASPS-31818), the specification of which is incorporated by reference herein in its entirety.

### TECHNICAL FIELD

The present invention relates to backup power systems, and more particularly, to a modular backup power system including a plurality of smart battery packs in one or more racks.

### BACKGROUND

Current customer premises power backup systems typically include a diesel engine electrical generator that provides direct AC power to the customer's premises, or alternatively, a bank of photovoltaic solar panels that are used to charge a bank of lead acid batteries that subsequently provide AC electricity through invertors that are connected to a premises distribution panel or junction box. Irrespective of the source of energy that is used to provide backup electrical power, whether from photovoltaic panels or from the utility grid, neither of these methods provides a particularly flexible use or implementation. Additionally, these solutions require a substantial financial expenditure up front in order to provide either a diesel backup engine or to provide the photovoltaic panels for generating the electricity in the bank of lead acid batteries for storing the energy. Thus, there is a need for a more cost effective and easier solution for providing backup power to a customer premises than those described herein above.

### SUMMARY

The present invention, as disclosed and described herein, in one aspect thereof, comprises a modular power backup system having a plurality of smart battery packs for storing electrical energy. Each of the plurality of smart battery packs includes a first power and control connector. A battery pack rack defines a plurality of slots for holding the plurality of smart battery packs. Each of the plurality of slots includes a second power and control connector for interconnecting with the first power and control connector of a smart battery pack of the plurality of smart battery packs. First control circuitry associated with the at least one battery pack rack selectively pools electrical energy from the plurality of smart battery packs into one or more electrical energy outputs.

### BRIEF DESCRIPTION OF THE DRAWINGS

For a more complete understanding, reference is now made to the following description taken in conjunction with the accompanying Drawings in which:

FIG. 1 is a block diagram illustrating the manner in which a plurality of smart battery packs are utilized for providing backup energy power via a rack-based system;

FIG. 2 provides a front view of a smart battery pack;

FIG. 3 provides a back view of the smart battery pack;

FIG. 4A illustrates a block diagram of a smart battery pack;

FIG. 4B illustrates a block diagram of system elements consisting of the smart battery pack that connects to various functional modular units to provide a basic portable solar generator solution;

FIG. 5 illustrates a front view of a rack for containing smart battery packs;

FIG. 6 provides a back view of the rack for containing smart battery packs;

FIG. 7 illustrates a block diagram of the control components of the rack;

FIG. 8 illustrates the manner in which a plurality of racks may be integrated and controlled;

FIG. 9 illustrates a block diagram of the system elements of the backup power system between various charging sources and a customer utility interface; and

FIG. 10 illustrates an example of a design implementation for modular grid power backup system.

### DETAILED DESCRIPTION

Referring now to the drawings, wherein like reference numbers are used herein to designate like elements throughout, the various views and embodiments of modular grid power backup system are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

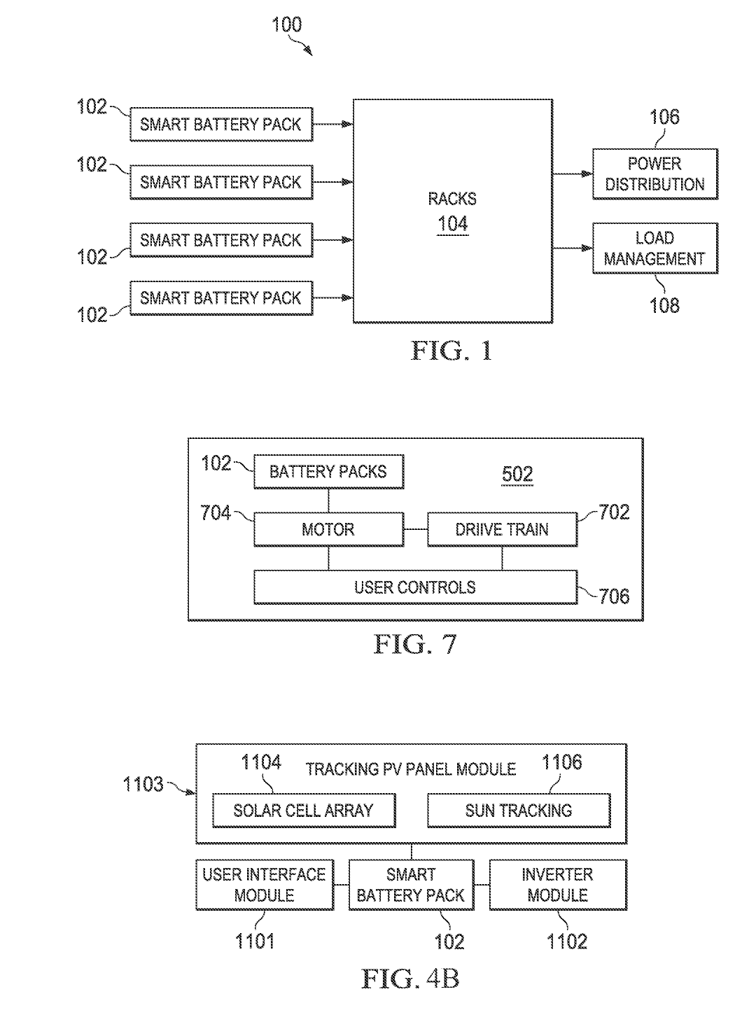

Referring now to the drawings, and more particularly to FIG. 1, there is illustrated a functional block diagram of a power storage backup system 100. The power storage backup system 100 includes one or more removable smart battery packs 102 that are electrically interconnected with each other upon insertion of the battery packs 102 into one or more racks 104 for charging or power supplying. A battery power distribution mechanism 106 associated with the rack 104 manages the utilization of the smart battery packs 102 as an energy source for providing power to various electric loads. The racks 104 additionally provide load circuit management 108 for managing the electricity supply to various load circuit at the customer premises that are interconnected with the energy providing racks.

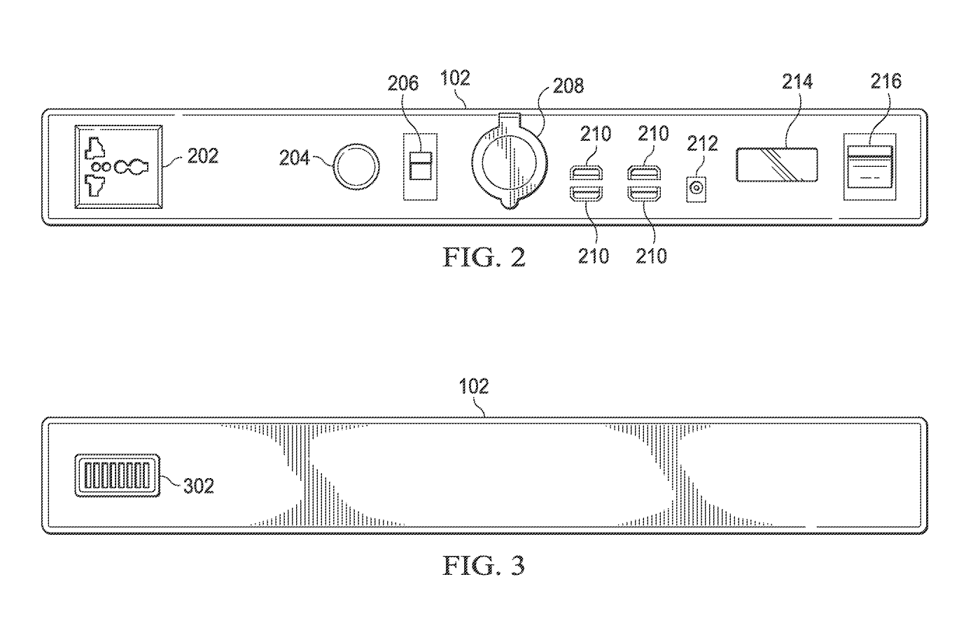

The implementation of the power storage backup system 100 of FIG. 1 depends upon a user's particular circumstances and financial ability. A user may initially begin with a single portable smart battery pack 102 as illustrated in FIGS. 2 and 3. FIG. 2 illustrates a front side panel of the smart battery pack 102 while FIG. 3 illustrates the back power interconnection side of the smart battery pack 102. Using a smart battery pack 102, a user may charge the battery pack 102 using a DC charger plugged into the power grid such that the battery pack is available as a portable backup power pack when needed. The front panel of the battery pack 102 includes a universal AC outlet 202 for providing an interconnection to the internal battery via the standard AC power plug connect. The AC on/off switch 204 comprises a push button or two-position switch which may be used for turning on and off power to the universal AC outlet 202. A 120/240-volt selector switch 206 enables a selection of either 120-volt power or 240-volt power at the AC outlet 202 providing power from the smart battery pack 102. A 12-volt DC output connector 208 allows the provision of 12-volt DC power through a DC power cord.

The output interface of the front panel additionally provides for USB outlets 210. The USB outlets 210 enable the connection of a USB connector to charge a device through the USB outlet 210. The front interface of the smart battery pack 102 additionally includes a 15-volt DC connector 212. This enables 15-volt DC power to be provided to the battery pack 102. The DC input voltage of 15-volts is just one of the possible implementations. All input and output voltages may be set to various values as necessitated by the intended application. A system status display 214 provides a window for displaying various types of system status information such as whether the battery pack is turned on and providing power and what type of power output or outputs are being provided from the battery pack 102. The main power switch 216 provides the manner for turning on and off the smart battery pack 102. The main power switch 216 enables the user to selectively provide power from the battery pack 102 as desired.

Referring now to FIG. 3, the back panel of the smart battery pack 102 is illustrated. The back panel provides a power and control connector 302. The power and control connector 302 enables the provision of stored battery power from the battery pack 102 when the battery pack 102 is included within a system rack as will be described more fully herein below. Additionally, the power and control connector 302 enables control of the battery pack 102 such that the energy stored by the battery pack 102 may be combined with the energy of other battery packs 102 when the battery pack is located within a system rack in order to provide a higher level of power to run larger load electrical devices.

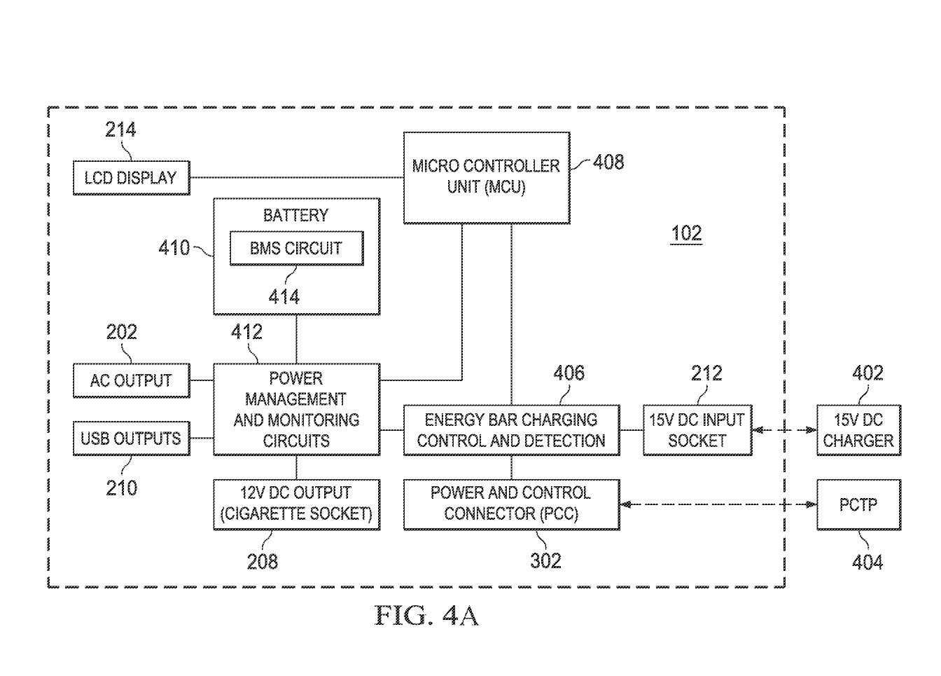

Referring now to FIG. 4A, there is provided a block diagram of a smart battery pack 102 according to one embodiment. The battery pack 102 may be charged in one of two manners. The battery pack 102 may be charged via a DC input socket which in FIG. 4A comprises a 15-volt input socket 212. The 15-volt DC input socket 212 interconnects with a 15-volt DC battery charger 402 that provides a charging voltage to the battery pack 102. The DC charger 402 would be powered either from a standard alternating current source or through a standard 12-volt cigarette lighter socket. Additionally, the battery pack 102 may be charged from its rear panel power and control connector 302. The power and control connector 302 mates with a power control termination point 404 on the rear of a battery pack rack 502 (see FIG. 6). The rack 502 is equipped with power control termination points that the battery pack 102 can mate with when the battery packs 102 are inserted within the rack 502.

When the battery pack 102 is inserted into a rack 502 for charging through the power control termination point 404, the 15-volt DC input socket 212 is disabled by the charging control and detection circuitry 406 responsive to commands from the microcontroller unit 408. In this situation, the charging control and detection circuitry 406 would receive an indication from the power and control connector 302 that the power control termination point 404 had been connected therewith. These indications would be forwarded to the microcontroller unit 408. The microcontroller unit 408 would instruct the control and connection circuitry 406 to disable the 15-volt DC input socket 212 while receiving the charging voltage from the power and control connector 302. The power and control connector 302, in addition to providing for the charging of the internal battery 410 of the battery pack 102, provides access to control and monitor the operation of the battery pack 102 from external control circuitries.

The battery pack 102 includes a microcontroller unit 408 which is responsible for controlling all monitoring and control operations within the smart battery pack 102. The microcontroller unit 408 provides a display signal to the LCD display 214 that provides status information with respect to the operation of the smart battery pack 102 in a visual manner through the front display 214. As discussed previously, the microcontroller unit 408 additionally communicates with the charging control and detection circuitry 406. The charging control and detection circuitry 406 detects a connection of either the 15-volt charging source 402 or power control termination point 404 at the associated 15-volt DC input socket connectors 212 and power and control connector 302. As discussed previously, when a power control termination point 404 is interconnected with the power and control connector 302, the 15-volt DC input socket 212 is disabled. Similarly, when the power and control connector 302 of the battery pack 102 is not connected to the power control termination point 404 and a charger is interconnected with the 15-volt DC input socket 212, the power and control connector 302 is disabled such that charging voltage comes solely through the 15-volt DC input socket 212.

The charging control and detection circuitry 406 is also interconnected with the power management and monitoring circuit 412 that provides connection of the charging voltages to the battery 410. In the charging mode, the power management and monitoring circuit 412 monitors the charge level of the battery 410 and continues providing a charging voltage from either the 15-volt DC input socket 212 or the power and control connector 302 until the power management and monitoring circuit 412 determines that the battery 410 is fully charged. Once the battery 410 is fully charged, the charging voltage would be disconnected from the battery 410 in order to prevent overcharging issues within the battery 410. The power management and monitoring circuits 412 additionally monitor for connections to each of the AC output 202, USB outputs 210 and 12-volt DC output 208 to determine if connections are provided to any of these outputs requiring the provision of output voltage thereto from the battery 410.

The power management and monitoring circuits 412 would include one or more DC to DC convertors for providing a DC voltage to the USB outputs 210 and to the 12-volt DC output 208 from the battery 410 when a DC power requiring load was connected. Additionally, the power management and monitoring circuit 412 would include one or more DC to AC invertors for providing an output AC voltage to the AC output 202 for AC connected loads. The battery 410 in one embodiment would comprise a lithium iron phosphate (also known as LFP) battery. It will be understood, of course, that other types of rechargeable batteries or other appropriate energy storage device would also be applicable. The battery 410 would include a built in battery management system 414 for managing charging and output of the battery 410.

An alternative implementation of the smart battery pack 102 separates the front user interface that is shown in FIGS. 2 from the smart battery pack 102 while maintaining the power and control connector 302 at the back as shown in FIGS. 3. The separated user interface module houses all, but not limited to, the interfaces shown in FIGS. 2 while also equipped with the power and control connector 302 to interface with the smart battery pack 102. In this implementation, both utilizing and replenishing the charge in smart battery pack 102 are not directly available. Both actions require the smart battery pack 102 to be connected to rack 104 or a User Interface module 1101 as shown in FIG. 4B.

Referring to FIG. 4B, a user interface module 1101 consists of, but is not limited to 110V/220V AC input, 15 VDC or higher DC input, high power USB output, 12V/24V DC output with various connector option such as DC plug, Anderson connector etc. The user interface module 1101 can be connected to a single or multiple smart battery packs 102 depending on the power requirements. To provide AC output, an inverter module 1102 can be connected. The tracking solar panel module 1103 consists of a solar cell array 1104 and sun tracking mechanism 1106 that always ensure that the solar panel is facing the sun, thus, working at its maximum efficiency. FIG. 4B shows how the functional modular unit is connected to provide a portable solar generator solution. The tracking PV panel module 1103 can be a waterproof suitcase design that comes with multiple compartments for housing the functional modular unit. The attachment between modules can either be a permanent fixed attachment or a detachable click or lock design. The functional modular unit is not limited to only what is shown in FIG. 4B. It can be further extended to cater to different lifestyle needs such as Wi-Fi router module, emergency lighting modules, portable speaker module, wireless charging module, etc.

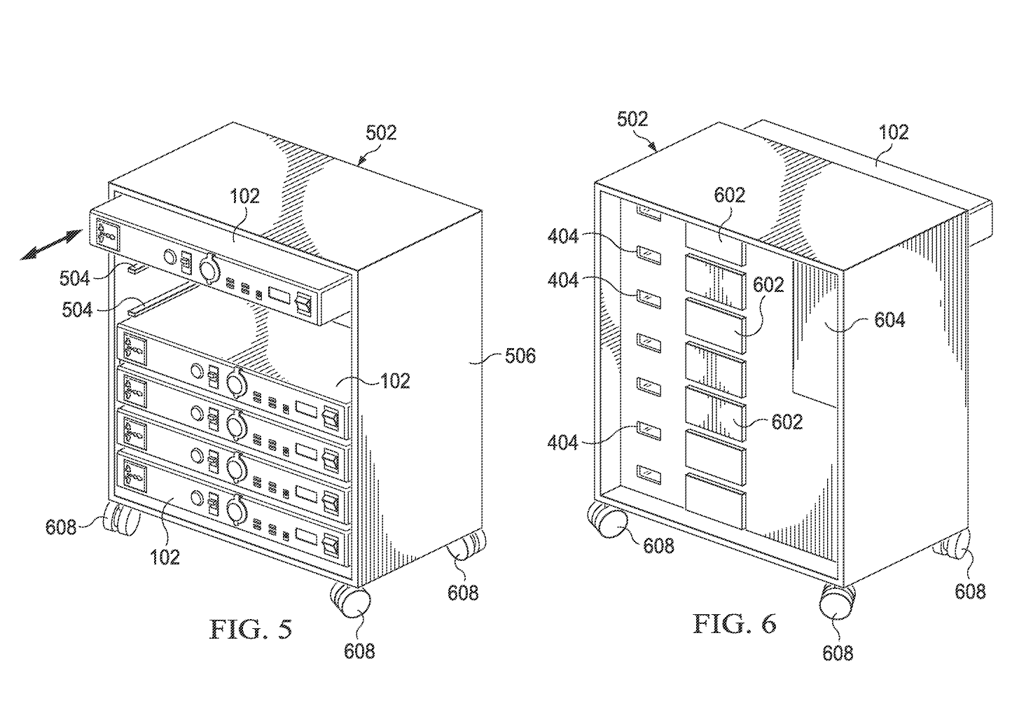

Referring now to FIGS. 5 and 6, there is illustrated a rack 502 configured to receive a plurality of smart battery packs 102 such that the battery packs 102 may be charged and the combined power outputs of the battery packs 102 may be combined into one or more outputs for powering higher power rated electrical loads. FIG. 5 illustrates a front view of the rack 502 while FIG. 6 illustrates the rear view. The rack 502 includes slots for containing up to seven battery packs 102. While the present configuration includes slots for receiving seven battery packs 102, configurations for a greater or lesser number of battery packs 102 are also possible. The rack 502 enables a user to use a single rack 502 to charge multiple battery packs 102. Once a battery pack is charged, it may be removed and another uncharged battery pack inserted into the rack 502. The battery packs 102 slide into the rack 502 on rails 504 locates on each side 506 of the rack 502. The battery packs 102 when inserted within the rack 502 on the rails 504 engage a power control termination point 404 with the power and control connector 302 of the battery pack 102. The power control termination point 404 enables the output power from the battery 410 within the battery pack 102 to be pooled together with power provided by other battery packs. Additionally, the power and control connector 302 provides interconnection with battery pack control circuits 602. Additionally, the user device interface 604 enables combined control of each of the battery packs 102 within a rack 502.

The rack 502 may have considerable weight associated therewith. Thus, in order to facilitate movement of the rack 502, a number of wheels or tracks 608 could be placed under the rack 502 to enable ease of movement. Additionally, a trolley power mechanism may also be utilized as more particularly illustrated in FIG. 7. Within the trolley-mounted mechanism a drive train 702 provides driven wheels or tracks 608 moving the rack 502 from one location to the other. The drive train 702 is powered by an electric motor 704 that drives the drive train 702. The motor 704 may be powered by the battery packs 102 within the rack 502. The trolley mechanism may additionally include user control 706 which enables the user to control the speed of the motor 704 and the operation of the drive train 702 in order to enable a user to drive or control movement of the rack 502 from one location to another. In alternative embodiments, the trolley mechanism might also include a standing platform enabling a user to ride with the rack 502 as the rack moves.

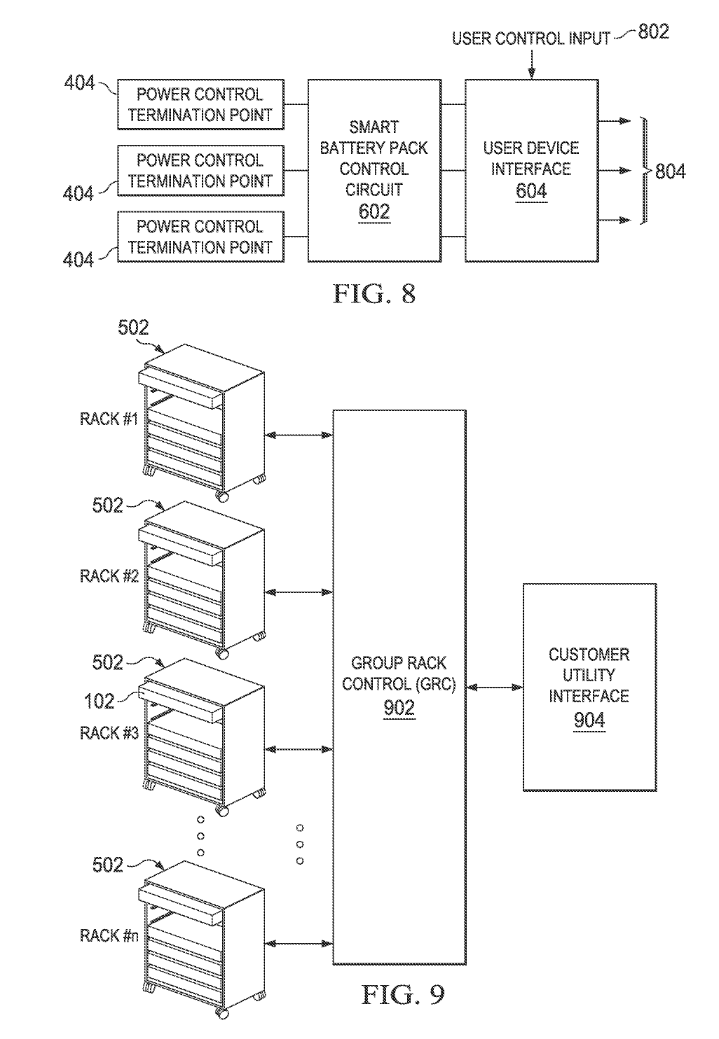

Referring now to FIG. 8, there is illustrated a functional block diagram of the interconnection between the power control termination point 404 on the back of each of the battery packs 102 within a rack 502 and its associated smart battery pack control circuit 602 associated with the rack 502. The smart battery pack control circuits 602 enable individual control of a battery pack 102 that is interconnected with the smart battery pack control circuits 602 through the power control termination point 404. The smart battery pack control circuits 602 manages the flow of current to and from the individual battery packs 102 as well as the polarity of connections of the individual battery packs. The smart battery pack control circuits 602 interconnect with the user device interface 604, which manages the connectivity of the circuits on the premises where the rack 502 is being utilized and connects the appropriate circuit breakers and control electronics to control the flow of electricity between the rack 502 and the circuits on a customer's premises.

A user device interface 604 enables pooled control of each of the battery packs 102 through the associated smart battery pack control circuits 602. User control inputs 802 are provided to the user device interface 604 to enable the power associated with each of the battery packs 102 within an associated rack 502 to be controlled in a desired manner. Implementation of the user control input 802 may be configured such that the user control input 802 can be effected remotely by means of communication medium (such as Wi-Fi or Internet), thus, allowing remote control and monitoring by user. The user device interface 604 may provide one or more outputs 804. The user device interface 604 may be configured by the user control inputs 802 such that each output 804 of the user device interface 604 goes to a separate connected electrical load. Alternatively, the user device interface 604 may pool together all or a portion of the power provided from individual battery packs 102 to provide power to higher power requiring loads. By pooling the power outputs from individual battery packs 102, the rack may obtain higher power capacity for various high power devices such as a microwave oven, refrigerator, dryer, washer, etc.

The user control inputs 802 enable the user to define the number of battery packs 102 that support the power needs of a specific circuit via the user device interface 604 which controls the smart battery pack control circuits 602 of battery pack 102. Thus, a varying number of battery packs 102 may be used to match the power needs of different premises circuit loads such as that for a washer/dryer, a refrigerator, etc. Additionally, one or more battery packs 102 may be taken out of service as a power backup element and removed to perform duties as a portable power source with various power outlets presented as a user interface without affecting the utility of the rack other than the reduction of power associated with the removal of the battery pack or packs. Thus, the battery packs 102 may be deployed as an off-grid automatic or manual power backup for the customer premises.

In addition to pooling power sources from multiple battery packs 102 within a single rack 502, the power providing services of multiple racks 502 may be pooled together to provide even greater power backup resources to a customer as more particularly illustrated in FIG. 9. Each rack 502 comprises an independent module comprising a varying number of battery packs 102. Several battery racks 502 or groups of such racks may be combined or pooled together to provide an aggregate power source of greater power and/or different voltage configurations by providing outputs and control from each of the rack 502 to a group rack control 902 via the user device interface 604 of each of the associated racks 502. The group rack control 502 connects to a customer utility interface 904 to provide connection to various load circuits on the customer's premises.

FIG. 9 illustrates (N) number of racks each of which is provisioned with five battery packs 102 but which may be provisioned with up to seven battery packs in this example. If each battery pack 102 provides 250 watt-hours of power, each fully provisioned rack 502 can provide a battery storage capacity of 1750 watt-hours. Thus, the four racks 502 would provide an aggregate power of 7,000 watt-hours to a customer's premises providing temporary backup for a typical home while enabling the customer to remove several battery packs 102 for internal or external use as portable power sources within or outside the premise. Since each rack 502 may be affixed to trolleys or equipped with wheels, each fully provisioned rack in the example may be used as a 1750 watt-hour portable electrical generator.

The group rack control 902 is a smart programmable controller that can automatically detect when a rack 502 is actively available to provide power. The group rack control 902 may also detect the number of battery packs 102 that are provisioned within a particular rack 502. As battery packs 102 are removed and used in other portable situations, some battery packs may require recharging time before they can be placed into service to provide power to the group rack control 902. Additionally, the group rack control 902 may generate control signals to activate or deactivate any battery pack 102 within a rack 502 so as to isolate the specific battery pack from active pooling duty. The group rack control 902 may also be programmed to selectively pool specific battery packs 102 and/or racks 502 for duty and to connect specific load circuits to specific battery packs and/or racks to prioritize the availability of power service to specific load circuits. Thus, various different loads such as a freezer, which requires uninterrupted power, may be accorded priority of service before a washer/dryer on a separate load circuit. The functionality of the group rack control 902 and other elements depicted in FIG. 9 may be distributed and designed into other elements of the modular customer premises grid power backup system.

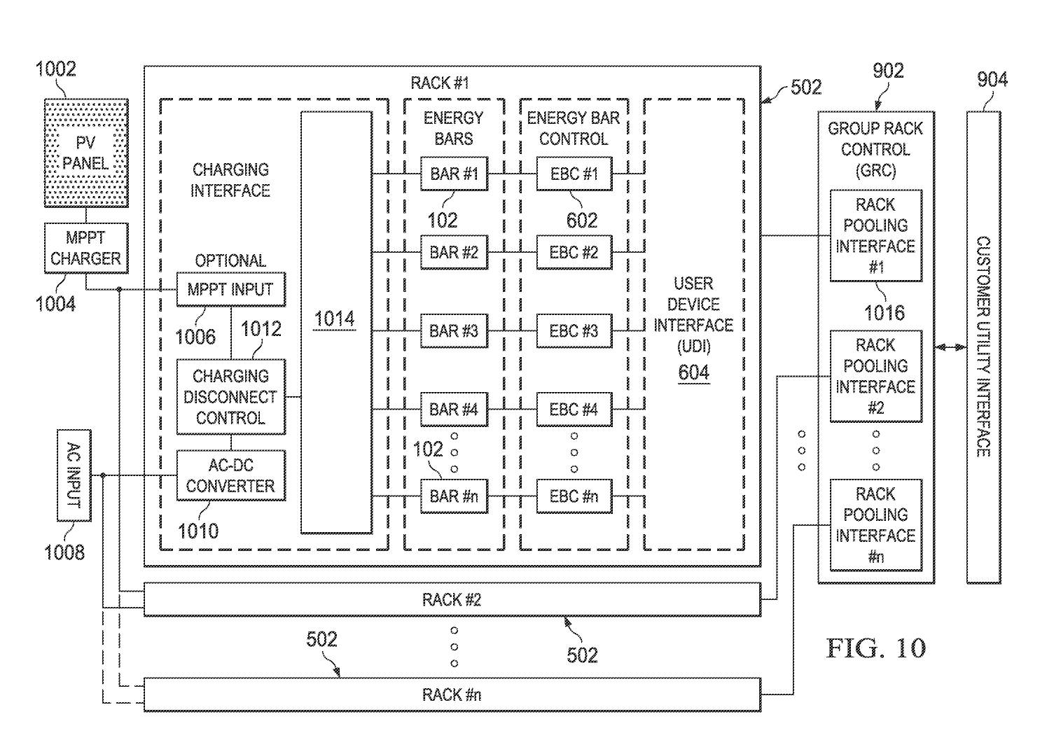

Referring now to FIG. 10, there is provided one example of a design implementation of the system of FIG. 9. The configuration illustrates a rack 502 or system of racks 502 that are powered by deploying photovoltaic panels 1002 or other alternative power sources to the premises with controllers that automatically switch between the grid electricity and alternative power sources to provide charging power to the battery packs 102 and racks 502. This option is depicted with a set of photovoltaic panels 1002 as the alternative power source. Each rack 502 converts to a photovoltaic panel assembly 102 whereupon the maximum power point transfer (MPPT) control element 1004 may be incorporated into the rack 502 rather than as a separate component. In the configuration of FIG. 10, the photovoltaic panels 1002 interconnect with the maximum power point transfer charger 1004. These panels may be of different output voltage configurations. The maximum power point transfer charger 1004 provides a charging power to each of the racks 502 through a maximum power point transfer input 1006. An AC charging input 1008 provides charging power to each of the racks 502 through associated AC to DC convertors 1010 within each of the racks 502.

A charging disconnect control circuit 1012 provides either the charging power provided from the photovoltaic panels 1002 or the AC input 1008 depending on which of these is currently available. The provided charging power from the charging disconnect control circuitry 1012 goes to charging and control circuitry 1014 within the rack 502 to provide the charging power to the various battery packs 102 placed within the rack 502. Each of the charged battery packs 102 provides power from its batteries to the associated battery pack control circuits 602. Battery pack control circuits 602 which then forward this power onto the user device interface 604 as described previously. The pooled output from the each individual racks 502 is provided to the group rack control 902 via connections to rack pooling interfaces 1016 within the group rack control 902. A connection may be established between the group rack control 902 and the customer utility interface 904 to provide power to the customer premises as necessary.

It will be appreciated by those skilled in the art having the benefit of this disclosure that using the above described modular power backup system, various levels of battery backup may be provided at a customer's premises. The customer may select and provide the amount of battery backup as desired depending upon a number of utilized battery packs and/or battery racks in order to configure their backup needs in a desired manner. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A modular power backup system, comprising:
at least one battery pack rack for holding a plurality of rechargeable battery packs;
first control circuitry associated with the at least one battery pack rack for selective pooling electrical energy from each of the at least one battery pack rack into one or more electrical energy outputs;
at least one battery pack within each of the at least one battery pack rack for storing the electrical energy; and
a second control circuitry associated with the at least one battery pack for selectively pooling the electrical energy from each of the at least one battery pack within a selected battery pack rack into one or more electrical energy outputs to the first control circuitry.

2. The modular power backup system of claim 1, wherein the first control circuitry further comprises:
a group rack control circuit for selective pooling electrical energy from each of the at least one battery pack rack into one or more electrical energy outputs;
at least one rack pooling interface each associated with one of the at least one battery pack rack for interconnecting control signals and the electrical energy from the associated battery pack rack to the group rack control circuit; and
a customer utility interface for interconnecting the group rack control circuit with a customer power load.

3. The modular power backup system of claim 1, wherein the second control circuit further comprises:
a battery pack control circuit associated with each battery pack of the at least one battery pack within a battery pack rack for controlling a flow of the electrical energy to and from the at least one battery pack and for controlling a polarity connection of the battery pack; and
a main control circuit for controlling flow of the electrical energy from the at least one battery pack control circuit in the battery pack rack to a designated external load.

4. The modular power backup system of claim 3, wherein the at least one battery pack rack further includes at least one power and control connector each interconnecting a battery pack with an associated battery pack control circuit and the main control circuit.

5. The modular power backup system of claim 1, wherein the at least one battery pack rack further includes:
a drive mechanism for moving the battery pack rack;
an electric motor for driving the drive mechanism using the electrical energy from the at least one battery packs; and
user controls for controlling operation of the drive mechanism and the electric motor to control movement of the at least one battery pack rack.

6. The modular power backup system of claim 1, wherein the at least one battery pack further includes a power and control connector for interconnecting power and control connection from the at least one battery pack to a battery pack rack.

7. The modular power backup system of claim 1, wherein the at least one battery pack further includes a DC input and an AC input for selectively charging the battery.

8. The modular power backup system of claim 7, wherein the at least one battery pack further comprises a maximum power point transfer input for receiving a charging voltage from a photovoltaic panel.

9. A modular power backup system, comprising:
a plurality of smart battery packs for storing electrical energy, each of the plurality of smart battery packs including a first power and control connector;
a battery pack rack defining a plurality of slots for holding the plurality of smart battery packs, each of the plurality of slots including a second power and control connector for interconnecting with the first power and control connector of a smart battery pack of the plurality of smart battery packs;
first control circuitry associated with the at least one battery pack rack for selective pooling electrical energy from the plurality of smart battery packs into one or more electrical energy outputs.

10. The modular power backup system of claim 9, wherein the at least one second control circuit further comprises:
a battery pack control circuit associated with the plurality of smart battery packs for controlling a flow of the electrical energy to and from the associated smart battery pack and for controlling a polarity connection of the smart battery pack; and
a main control circuit for controlling a flow of the electrical energy from the plurality of battery pack control circuits in the battery pack rack to at least one designated external load.

11. The modular power backup system of claim 10, wherein the second power connecter further interconnects the associated smart battery pack with the associated battery pack control circuit and the main control circuit.

12. The modular power backup system of claim 9, wherein the at least one battery pack rack further includes:
a drive mechanism for moving the battery pack rack;
an electric motor for driving the drive mechanism using the electrical energy from the plurality of battery packs; and
user controls for controlling operation of the drive mechanism and the electric motor to control movement of the at least one battery pack rack.

13. The modular power backup system of claim 9, wherein the at least one battery pack further includes a DC input and an AC input for selectively charging the battery.

14. The modular power backup system of claim 13, wherein the at least one battery pack further comprises a maximum power point transfer input for receiving a charging voltage from a photovoltaic panel.

15. The modular power backup system of claim 9 further including a rack pooling control circuitry associated with the battery pack rack and at least one other battery pack rack for selectively pooling the electrical energy from each of the battery pack racks into one or more electrical energy outputs to designated electrical loads.

16. The modular power backup system of claim 15, wherein the rack pooling control circuit further comprises:
a group rack control circuit for selective pooling electrical energy from each of the battery pack racks into the one or more electrical energy outputs to designated electrical loads;
at least one rack pooling interface each associated with one of the battery pack racks for interconnecting control signals and the electrical energy from the associated battery pack rack to the group rack control circuit; and
a customer utility interface for interconnecting the group rack control circuit with the designated electrical loads.

17. A method for providing backup power, comprising:
storing electrical energy within a plurality of rechargeable battery packs;
interconnecting power and control circuits of each of the plurality of rechargeable packs within a battery pack rack defining a plurality of slots for holding the plurality of rechargeable battery packs;
selectively pooling electrical energy from the plurality of rechargeable battery packs into one or more electrical energy outputs.

18. The method of claim 17, wherein the step of pooling further comprises:
controlling a flow of the electrical energy to and from the associated rechargeable battery pack;
establishing a polarity connection of the rechargeable battery pack; and
controlling a flow of the electrical energy from the battery pack rack to at least one designated external load.

19. The method of claim 17 further including the step of selectively charging the rechargeable battery pack using either a DC input and an AC input.

20. The method of claim 19 further including the step of selectively charging the rechargeable battery pack using a photovoltaic panel.

21. The method of claim 9 further including:
connecting power and control circuits of the battery pack rack with power and control circuits of at least one other battery pack rack; and
selectively pooling the electrical energy from each of the battery pack racks into one or more electrical energy outputs to designated electrical loads.

22. The method of claim 21, wherein the step of selectively pooling further comprises:
selective pooling electrical energy from each of the battery pack racks into the one or more electrical energy outputs to designated electrical loads;
interconnecting control signals and the electrical energy from the associated battery pack rack; and
interconnecting the electrical energy outputs with the designated electrical loads.
